(19) United States
(12) Patent Application Publication
(10) Pub. No.: US 2026/0313406 A1
(43) Pub. Date: Oct. 8, 2026

(54) CONTROL APPARATUS, COMMUNICATION SYSTEM, DETERMINATION METHOD, AND PROGRAM

(71) Applicant: NTT, Inc., Tokyo (JP)

(72) Inventors: Kotaro ONO, Tokyo (JP); Kazuhiro TOKUNAGA, Tokyo (JP); Takehiro FUJINAGA, Tokyo (JP); Takuya TOJO, Tokyo (JP); Takeshi KUWAHARA, Tokyo (JP)

(21) Appl. No.: 19/481,334

(22) PCT Filed: May 12, 2023
(86) PCT No.: PCT/JP2023/017963

§ 371 Date: Nov. 4, 2025

(51) Int. Cl. H04W 24/08

(52) U.S. Cl. CPC H04W 24/08

(57) ABSTRACT

A control apparatus configured for determining a communication priority for communication of a device, the control apparatus including: an estimation unit configured to estimate quality related to the communication for each communication priority; and a determination unit configured to determine the communication priority for the communication of the device based on the quality for the each communication priority estimated by the estimation unit and a requirement condition of the communication.

### TECHNICAL FIELD

The present invention relates to a technique for determining a QoS control level.

### BACKGROUND ART

Non Patent Literature 1 discloses a control system of Voice over LTE (VOLTE) and the like as a conventional wireless communication technology.

In a conventional wireless communication technology such as VOLTE, a network (NW) resource that meets a quality requirement of a level required from a device according to communication contents such as voice and video is statically allocated to the communication.

### CITATION LIST

### Non Patent Literature

Non Patent Literature 1: Tokunaga et al., Development of VOLTE to Realize New Voice Services, NTT DOCOMO Technical Journal, Vol.22 No.2, pp.7-23

### SUMMARY OF INVENTION

### Technical Problem

In the related art, only an NW resource that meets a request from a device is allocated to communication. Therefore, there is a possibility that the allocated NW resource is not appropriate for a situation of a device or communication, and the like. For example, when excessive NW resources are allocated, efficient NW resources cannot be utilized. Such a problem is caused by a fact that an appropriate quality of service (QoS) control level according to a situation is not applied. Note that, in the present specification, it is assumed that best effort communication is also one of QoS control levels.

The present invention has been made in view of the above points, and an object thereof is to provide a technique capable of determining an appropriate QoS control level according to a situation.

### Solution to Problem

According to the disclosed technique, provided is a control apparatus configured for determining a communication priority for communication of a device, the control apparatus including:
an estimation unit configured to estimate quality related to the communication for each communication priority; and
a determination unit configured to determine the communication priority for the communication of the device based on the quality for the each communication priority estimated by the estimation unit and a requirement condition of the communication.

### Advantageous Effects of Invention

According to the disclosed technique, it is possible to determine an appropriate QoS control level according to a situation.

### BRIEF DESCRIPTION OF DRAWINGS

FIG. 1 is a diagram illustrating an image of QoS control.

FIG. 2 is a diagram for explaining an example of dynamic application of a QoS control level.

FIG. 3 is a configuration diagram of a communication system.

FIG. 4 is a configuration diagram of a control apparatus 100.

FIG. 5 is a flowchart for explaining an operation of the control apparatus 100.

FIG. 6 is a diagram illustrating an example of information stored in a storage unit 150.

FIG. 7 is a diagram illustrating an image of a resource allocated to information transmission at each QoS control level.

FIG. 8 is a diagram for explaining a concept of a method of determining a specific condition.

FIG. 9 is a flowchart of Example 1.

FIG. 10 is a flowchart of Example 2.

FIG. 11 is a diagram illustrating a hardware configuration example of the control apparatus 100.

### DESCRIPTION OF EMBODIMENTS

Hereinafter, an embodiment of the present invention (present embodiment) will be described with reference to the drawings. The embodiment to be described below is merely exemplary, and embodiments to which the present invention is applied are not limited to the following embodiment. Note that “/” to be used in the following description means “or”. For example, “A/B” is “A or B”. However, “A/B” does not mean “only one of A and B”, and “both A and B” is also included in the meaning of “A/B”.

Furthermore, in the following description, the target to be determined is a QoS control level, but the QoS control level is an example of a communication priority.

Those other than the “QoS control level” may be used as the “communication priority”.

### Problems

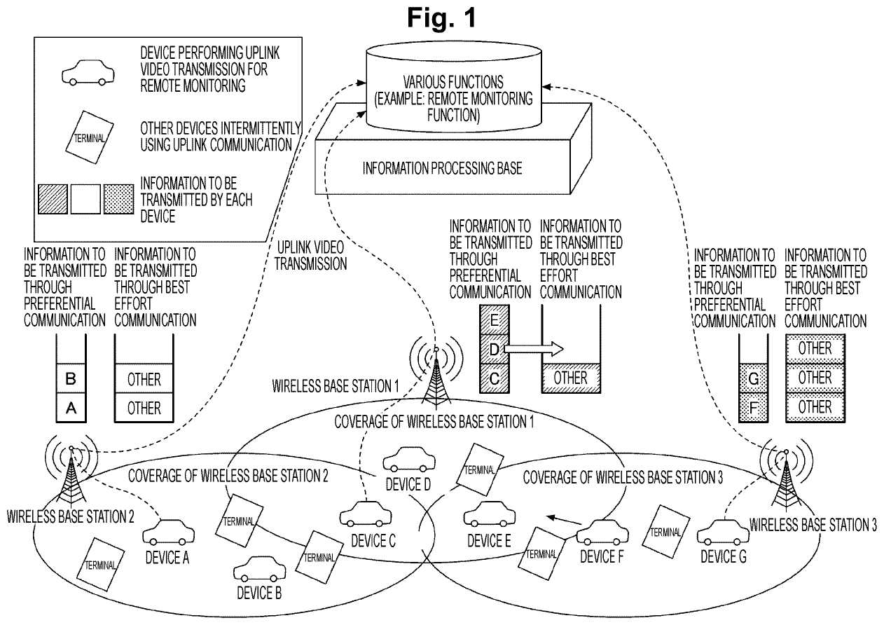

First, problems with the present embodiment will be described in detail with reference to FIG. 1. FIG. 1. illustrates a communication environment in which three wireless base stations 1 to 3 form three coverages. In each coverage, as illustrated, a device that performs uplink video transmission for remote monitoring and other devices (for example, a terminal such as a general smartphone) that intermittently use uplink communication exist.

The device, which performs the uplink video transmission for remote monitoring, is a communication device mounted on a connected car, for example. In the example illustrated in FIG. 1, a remote monitoring function or the like on the information processing base receives a video from the device and performs remote monitoring. In such a use case, the use of the wireless access NW is a premise as illustrated in FIG. 1.

FIG. 1 illustrates an image of QoS control performed in each wireless base station. For example, in the wireless base station 2, transmission information of a device A and transmission information of a device B are treated as information to be transmitted through preferential communication, and transmission information of the other devices are treated as information to be transmitted through best effort communication. QoS control is also performed on the wireless base stations 1 and 3 as illustrated in the drawing.

In a use case such as remote monitoring of a connected car, it is assumed that it is necessary to meet a use case requirement of continuously performing real-time video transmission of a certain quality or higher.

In order to meet the use case requirement, while it is necessary to secure the resources of the wireless access NW, since the resources of the wireless are particularly limited, it is difficult to secure the resources for all the devices at all times.

That is, even in preferential communication such as the uplink video transmission for remote monitoring, which is a target of QoS control, resources used for preferential communication are congested if the priority is always increased.

In the example of FIG. 1, it is difficult to secure wireless resources in advance for all the devices A to G that can perform the uplink video transmission for remote monitoring.

Therefore, it is desirable to perform an operation of dynamically changing the QoS control level so as to increase the priority only in a situation where it is necessary to increase the priority. In order to realize appropriate dynamic change of the QoS control level, it is necessary to appropriately determine what QoS control level is applied to communication of each device.

For example, in FIG. 1, the device D existing in the coverage of the wireless base station 1 is close to the wireless base station 1, and the radio wave propagation environment is good. Therefore, since sufficient video transmission quality can be obtained even in the best effort communication, the QoS control level is changed for the video transmission of the device D, so that the information transmission is performed by the best effort communication, and the video transmission of the device F newly entering the coverage of the wireless base station 1 from the outside is performed by the preferential communication. A specific technique for enabling dynamic change of the QoS control level as described above will be described below.

### Outline of Embodiment

In the present embodiment, in order to solve the above problem, a control apparatus 100 to be described later estimates NW quality/application quality that can be achieved at each QoS control level, and dynamically determines (changes) a QoS control level to be applied to communication of each device on the basis of the estimation result. Note that the NW quality and the application quality may be collectively referred to as “quality”.

The control apparatus 100 estimates the NW quality/application quality that can be achieved at each QoS control level (including best effort communication) for a device using any one or any plurality (or all) of the “time/position, radio wave propagation environment, and accumulated past information” for the device (or various devices). The “past information” is any one or any plurality (or all) of the past “time/position, quality prediction result, applied QoS control level, and control result (quality measurement result)” for the device (or various devices).

For example, the control apparatus 100 estimates the NW quality/application quality that can be achieved at each QoS control level (including best effort communication) on the basis of a relationship between any plurality (or all) of pieces of information of “time/position, radio wave propagation environment, and accumulated past information”. The estimation of the quality in the present embodiment is assumed to be estimation (prediction) of the future quality that can be used for proactive control, but is not limited thereto.

An example of estimation using the relationship will be described. Here, a case is considered where the quality (throughput, and packet loss rate, as an example) of each QoS control level one second after the current time of a specific device is estimated.

It is assumed that the control apparatus 100 accumulates the throughput actual value and the packet loss rate actual value for each past time, each position, and each QoS control level. The control apparatus 100 estimates the position after one second (referred to as time T) from the moving direction and the moving speed of the specific device, acquires the throughput actual value and the packet loss rate actual value corresponding to the position and the time T from the accumulated information, and these actual values as the quality estimation result.

Note that this is an example, and the estimation may be performed using a technique such as regression analysis or machine learning.

Basically, the control apparatus 100 determines the QoS control level at which the estimation result of the NW quality/application quality meets (exceeds) the quality of the use case requirement/user request to be the QoS control level to be applied to the communication of the device. Note that the use case requirement/user request may be referred to as a communication requirement condition.

In the present embodiment, the control apparatus 100 can determine the QoS control level to be applied to the communication of the device using only the above determination criterion, or in consideration of whether the QoS control level one level lower than the lowest QoS control level estimated to exceed the quality of the use case requirement/user request can exceed the quality of the use case requirement/user request (whether there is room for exceeding), the control apparatus 100 can determine the QoS control level one level lower than the lowest QoS control level to be the QoS control level to be applied to the communication of the device. Furthermore, in some situations, a QoS control level that is N (>2) stages lower than the lowest QoS control level estimated to exceed the quality of the use case requirement/user request can be determined to be the QoS control level to be applied to communication of the device.

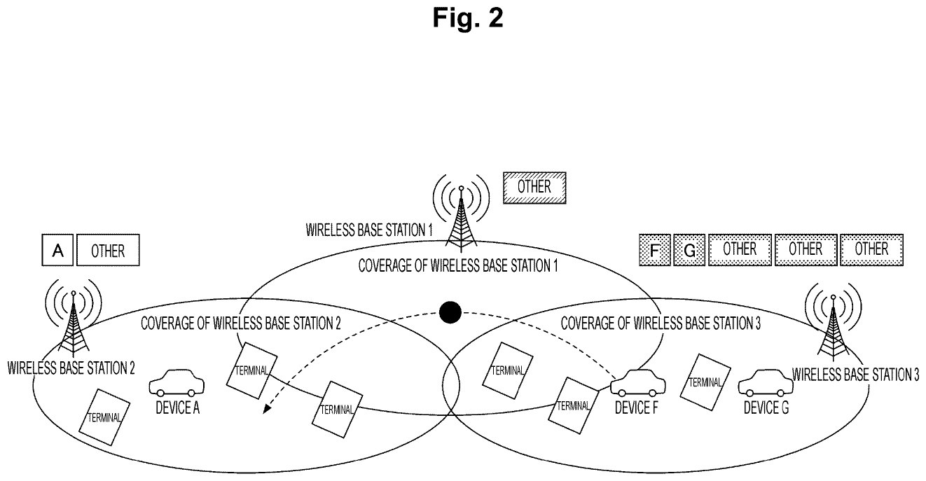

A specific example will be described with reference to FIG. 2. Similarly to FIG. 1, FIG. 2 illustrates a communication environment in which a device that performs uplink video transmission for remote monitoring and another device that intermittently uses uplink communication exist in three coverages.

Here, a situation is assumed in which a device F moves from the coverage of the wireless base station 3 to the coverage of the wireless base station 1 and further moves to the coverage of the wireless base station 2 as illustrated in the drawing.

Traffic is congested within the coverage of the wireless base station 3. Therefore, the control apparatus 100 determines that the use case requirement/user request cannot be met unless the QoS control level is “high” (high priority) with respect to the communication of the device F, and applies the QoS control level “high” to the uplink video transmission of the device F.

Traffic is not congested within the coverage of the wireless base station 1. Therefore, the control apparatus 100 determines that the use case requirement/user request of the device F can be met even in the best effort communication, and applies the best effort communication to the video transmission of the device F within the coverage.

Traffic is slightly congested within the coverage of the wireless base station 2. Therefore, the control apparatus 100 determines that the best effort communication cannot meet the use case requirement/user request, but that these can be met at the QoS control level “high” or “medium” with respect to the device F. Therefore, the control apparatus 100 applies the QoS control level “medium” to the uplink video transmission of the device F.

In the above example, the example has been described in which the quality degradation is caused by the congestion of the traffic. However, also in a case where the quality degradation is caused by the degradation of the radio wave propagation environment or the like, similarly, the QoS control level to be applied can be dynamically changed on the basis of the quality or the like that can be achieved in each QoS control level.

### System Configuration Example

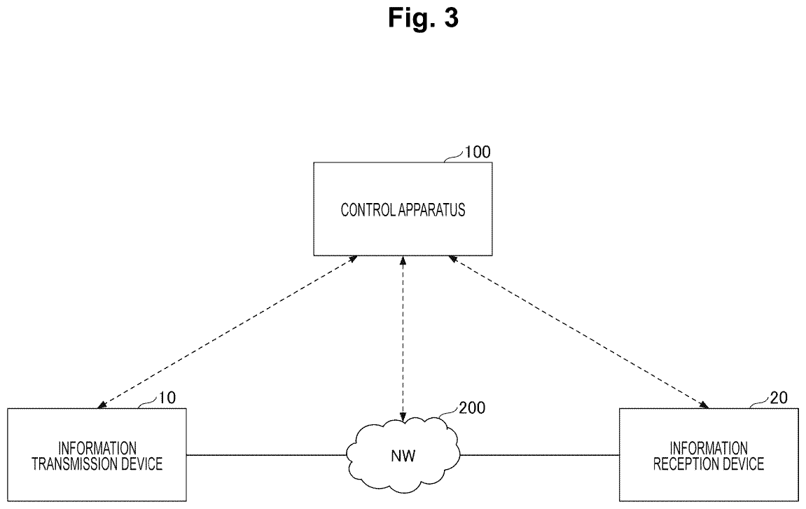

FIG. 3 illustrates a configuration example of a communication system in the present embodiment. As illustrated in FIG. 3, the communication system includes an information transmission device 10, an information reception device 20, and a control apparatus 100. The information transmission device 10 transmits information to the information reception device 20 via an NW 200.

The information transmission device 10 corresponds to, for example, a device that performs the above-described uplink video transmission. Furthermore, the information reception device 20 corresponds to, for example, the remote monitoring function described above.

The NW 200 is assumed to be a network having a wireless access network and a core network in mobile communication, but is not limited thereto. For example, the NW 200 may be only a wireless access network, only a core network, or a fixed network. The wireless access network may be 3G, 4G, 5G, 6G, a wireless LAN, or the like, or may be other networks. Furthermore, the NW 200 may be switched as the information transmission device 200 moves.

The “resource” appearing below is a resource of the NW 200. For example, when the NW 200 is a wireless access network, the resource is a wireless resource.

The control apparatus 100 can communicate with any of the information transmission device 10, the information reception device 20, and the NW 200. For example, the control apparatus 100 acquires the position information of the information transmission device 10 from the information transmission device 10 together with the time information when the information transmission device 10 is at the position, and acquires an NW quality measurement result from the information reception device 20. Furthermore, the control apparatus 100 can acquire received radio wave intensity (radio wave propagation environment information) from the information transmission device 10.

The control apparatus 100 may acquire the position information, the NW quality measurement result, the received radio wave intensity, and the like from the NW 200.

Furthermore, the control apparatus 100 can instruct the NW 200 (or the information transmission device 10) on the QoS control level to be applied to communication of the information transmission device 10.

In FIG. 3, one information transmission device 10 and one information reception device 20 are illustrated for convenience of description, but in general, there are a plurality of information transmission devices 10 and a plurality of information reception devices 20.

### Configuration of Device and Outline of Operation

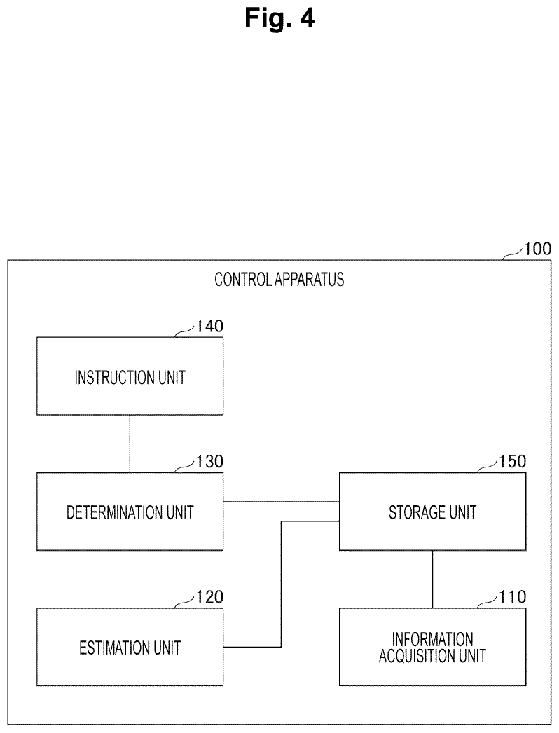

FIG. 4 illustrates a configuration example of the control apparatus 100. As illustrated in FIG. 4, the control apparatus 100 includes an information acquisition unit 110, an estimation unit 120, a determination unit 130, an instruction unit 140, and a storage unit 150.

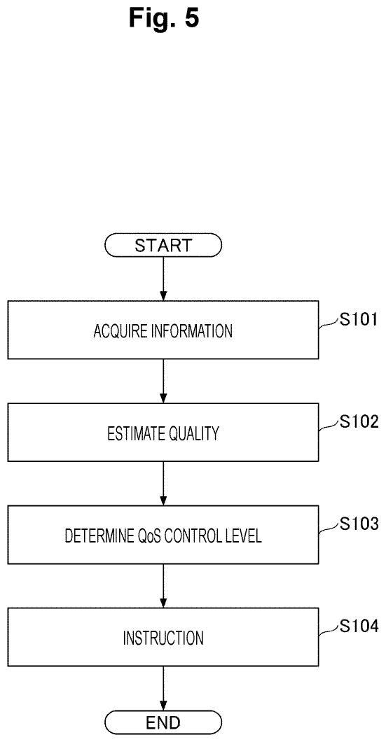

The outline of the operation of the control apparatus 100 will be described with reference to the flowchart in FIG. 5. In S101, the information acquisition unit 110 acquires information necessary for estimating the NW quality/application quality that can be achieved at each QoS control level. The acquired information is stored in the storage unit 150. Note that parameters such as threshold values are stored in the storage unit 150 in advance. The information acquisition in S101 is performed as needed, and the above-described “time/position, radio wave propagation environment, and past information” is stored in the storage unit 150 in S101.

In S102, the estimation unit 120 reads the information acquired in S101 from the storage unit 150, and estimates the NW quality/application quality that can be achieved at each QoS control level for the target device (here, the information transmission device 10) by using the information. The estimation result is stored in the storage unit 150.

In S103, the determination unit 130 reads the estimation result obtained in S102 from the storage unit 150, and determines the QoS control level to be applied in the communication of the information transmission device 10 on the basis of the estimation result. The determined QoS control level is stored in the storage unit 150 and notified to the instruction unit 140.

In S104, the instruction unit 140 instructs the NW 200 to apply the determined QoS control level to the communication of the information transmission device 10.

The QoS control determination/instruction by the flow in FIG. 5 may be performed at predetermined time intervals for each device, may be performed when a change equal to or greater than a predetermined threshold occurs in the quality estimation result, may be performed when the position of the device changes equal to or greater than a predetermined threshold, or may be performed by other triggers.

### Method of Determining QoS Control Level

Next, a method of determining the QoS control level executed by the determination unit 130 will be described in detail. The determination unit 130 determines the QoS control level by comparing the use case requirement/user request with the NW quality/application quality that can be achieved at each QoS control level.

Basically, the determination unit 130 determines the lowest (in priority level) QoS control level (L₁) that meets the use case requirement/user request to be the QoS control level to be applied to the communication of the information transmission device 10. In a case where a specific condition is met, the determination unit 130 may determine a QoS control level (L₂) lower (in priority level) than L₁.

### Specific Example

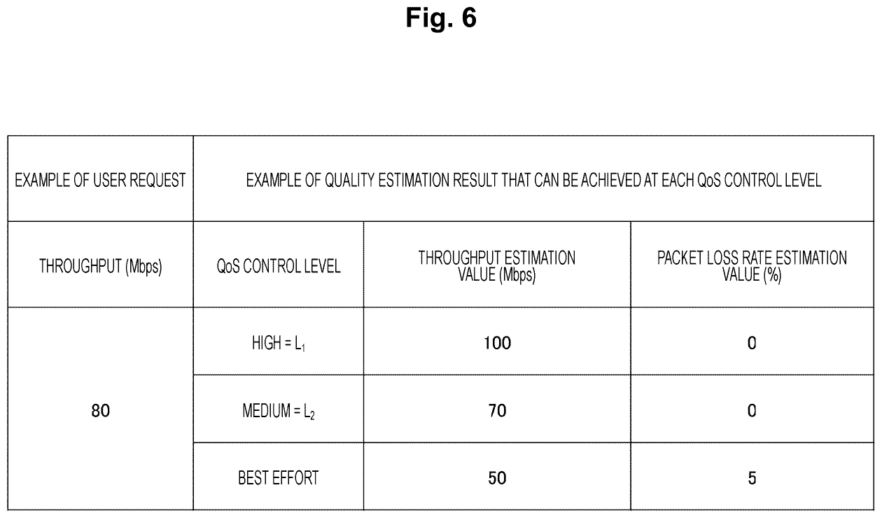

A specific example will be described. It is assumed that the information illustrated in FIG. 6 is stored in the storage unit 150 by information acquisition by the information acquisition unit 110 and quality estimation by the estimation unit 120. As illustrated in FIG. 6, a user request for communication of the information transmission device 10 is “throughput=80 Mbps”. Note that “throughput=80 Mbps” may be a use case requirement.

Furthermore, the estimation result of the quality that can be achieved at each QoS control level (here, the throughput estimation value and the packet loss rate estimation value) for the communication of the information transmission device 10 is “100 Mbps when the QoS control level is high=L₁, 70 Mbps when the QoS control level is medium=L₂, and 50 Mbps when the QoS control level is best effort” with respect to the throughput estimation value.

Furthermore, the packet loss rate estimation value is “0% when the QoS control level is high=L₁, 0% when the QoS control level is medium=L₂, and 5% when the QoS control level is best effort”.

In this situation, the determination unit 130 determines L₁=high, which is the lowest QoS control level basically meeting the user request, to be the QoS control level to be applied to the communication of the information transmission device 10.

Furthermore, when determining that the specific condition is met, the determination unit 130 can determine a QoS control level (here, L₂=medium) lower than L₁ to be the QoS control level applied to the communication of the information transmission device 10.

The specific condition is, for example, “the estimation result of L₁ sufficiently exceeds the user request, and the estimation result of L₂ is close to the user request”. “The estimation result of L₂ is close to the user request” may be paraphrased as “the estimation result of L₂ has room to exceed the user request”.

Moreover, in the present embodiment, as a specific condition, whether “there is a high possibility that the actual quality meets the user request even when L₂ is applied” is determined on the basis of the packet loss rate estimation value. Details thereof will be described later.

### Advantages of Application of L₂

By using L₂ as the QoS control level, it is possible to efficiently utilize resources by avoiding excessive securement of limited resources (for example, wireless resources).

Furthermore, by using L₂ as the QoS control level, it is easy to continue estimation of the NW quality/application quality that can be achieved at a low QoS control level, such as the best effort communication essential for avoiding excessive securing of resources.

For example, an application record of each QoS control level is essential for quality prediction based on a relationship between the past “time/position, applied QoS control level, and control result (quality measurement result)” for various devices. Therefore, it is desirable to avoid convergence from stage 1 to stage 4 as described below, and by applying L₂, the convergence as described below can be avoided.
Stage 1: There is a tendency to apply a high QoS control level to communication of each device on the premise of QoS control level application on the safety side.
Stage 2: Application record of a low QoS control level is decreased.
Stage 3: Estimation of the quality that can be achieved at a low QoS control level is not possible.
Stage 4: As a result of having to apply a high QoS control level, efficient utilization of limited resources based on dynamic change of the QoS control level is not possible.

### Method of Determining QoS Control Level in Consideration of Packet Loss Rate

As described above, when determining that the specific condition is met for the communication of the information transmission device 10, the determination unit 130 can determine a QoS control level (here, L₂=medium) lower than L₁ to be the QoS control level applied to the communication of the information transmission device 10.

As described above, the specific condition is, for example, that “the estimation result of sufficiently exceeds the user request, and the estimation result of L₂ is close to the user request”, and in addition, that “there is a high possibility that the actual quality meets the user request even when L₂ is applied”.

In the present embodiment, the determination unit 130 determines whether or not “there is a high possibility that the actual quality meets the user request even when L₂ is applied” on the basis of the packet loss rate estimation value. Here, the method will be described.

### Communication As Premise

Communication that is a premise for performing determination on the basis of the packet loss rate estimation value will be described.

A resource (here, a wireless resource is assumed) used in the communication is a limited resource. Therefore, in order to efficiently utilize the resource, the resource is shared at each QoS control level. Therefore, the quality of communication using the resource is mutually affected between a plurality of QoS control levels.

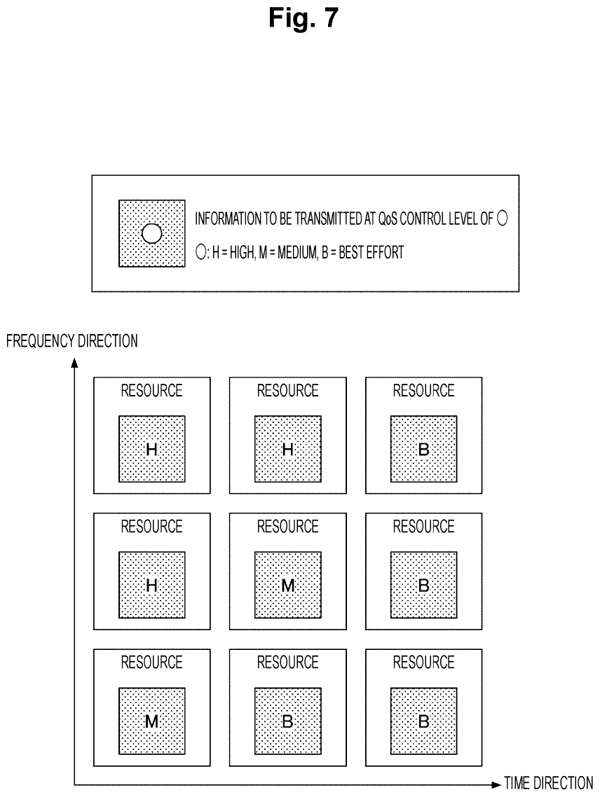

FIG. 7 illustrates an image of a resource (time and frequency resources) allocated to information transmission at each QoS control level. In a case where communication at a plurality of QoS control levels occurs at the same time, while a resource is preferentially allocated to communication at a high QoS control level, an operation of securing a resource at all times is not performed.

### Concept of Determination Method

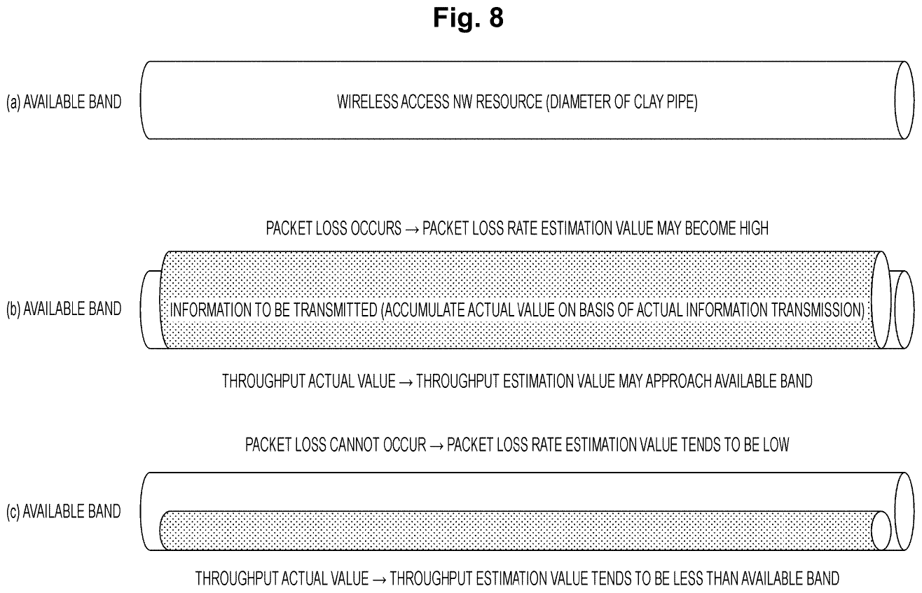

A concept of a method of determining a specific condition will be described with reference to FIG. 8. (a) in FIG. 8 illustrates a state in which a resource (available band) for communication is allocated but information is not transmitted.

(b) in FIG. 8 illustrates a state in which information more than or equal to that can be transmitted in the available band is transmitted and packet loss occurs. In the state of (b), there is a high possibility that the estimation value of the packet loss rate becomes high. Furthermore, since the throughput actual value on which the throughput estimation is based becomes high, there is a high possibility that the throughput estimation value approaches the available band.

(c) in FIG. 8 illustrates a state in which information less than that can be transmitted in the available band is transmitted and packet loss cannot occur. In the state of (c), the packet loss rate estimation value tends to be low. Furthermore, since the throughput actual value on which the throughput estimation is based becomes low, the throughput estimation value tends to be less than the available band.

In a case where the packet loss rate estimation value is low, since it is considered to be in the state of (c), there is a possibility that the actual available band is larger than the throughput estimation value. Therefore, in a case where the packet loss rate estimation value is low, the determination unit 130 can determine that “there is a high possibility that the actual quality meets the user request even when L₂ is applied”. “There is a high possibility that the actual quality meets the user request even when L₂ is applied” may be paraphrased as “there is a high possibility that the quality estimation value of L₂ is smaller than the available band”.

As described above, since limited resources (e.g., wireless resources) are shared at each QoS control level for efficient utilization, quality is mutually affected. Furthermore, the throughput estimation value in a case where the packet loss rate estimation value is high is close to the available band, and the throughput estimation value in a case where the packet loss rate estimation value is low is a value with a margin for the available band.

Therefore, in the present embodiment, for example, the determination unit 130 determines the QoS control level on the basis of “the packet loss rate estimation value” and “a difference between the throughput estimation value and the user request” for L₁ and L₂.

### Specific Example of Determination

A specific example of determination of a specific condition by the determination unit 130 will be described using the information in FIG. 6 as an example. In the present example, the lowest QoS control level that meets the user request is L₁. The QoS control level lower than L₁ (the highest among the levels that do not meet the user request) is L₂.

Since the packet loss rate estimation value when the QoS control level is high=L₁ is 0%, the determination unit 130 can determine that there is a possibility that the available band when the QoS control level is high is greater than 100 Mbps, and there is a low possibility that the available band when the QoS control level is medium is less than 70 Mbps. In this case, it can be determined that there is a high possibility that the actual quality meets the user request even when La is applied.

Furthermore, since the packet loss rate estimation value when the QoS control level is medium=L₂ is 0%, the determination unit 130 can determine that there is a possibility that the available band when the QoS control level is high is greater than 100 Mbps, there is a possibility that the available band when the QoS control level is medium is greater than 70 Mbps, and there is a low possibility that the available band when the QoS control level is best effort is less than 50 Mbps. That is, in this case, it can be determined that there is a high possibility that the actual quality meets the user request even when L₂ is applied.

Furthermore, since the packet loss rate estimation value when the QoS control level is best effort is 5%, the determination unit 130 can determine that there is a low possibility that the available band when the QoS control level is best effort is greater than 50 Mbps. This is because packet loss is expected to some extent.

The determination unit 130 can determine whether “the estimation result of L₁ sufficiently exceeds the user request” and “the estimation result of L₂ is close to the user request” by comparing the magnitude of a difference between the throughput estimation value and the user request with a preset threshold value. The difference may be a subtraction difference or a division difference (that is, a ratio).

### Detailed Example of QoS Control Level Determination

Next, a detailed processing example of determining the QoS control level by the determination unit 130 will be described. Here, two examples will be described as Example 1 and Example 2. Moreover, an operation example using time/position information will be described as Example 3.

### Example 1

In Example 1, the determination unit 130 determines the QoS control level to be applied to the communication of the information transmission device 10 on the basis of the packet loss rate estimation value and the throughput estimation value for L₁ and L₂.

Specifically, when determining that “there is a high possibility that the throughput estimation value of L₁ is smaller than the available band=quality degradation of L₂ due to the presence of L₂ is unlikely to occur”, “L₁ sufficiently exceeds the user request”, “there is a high possibility that the throughput estimation value of L₂ is smaller than the available band”, and “L₂ is close to the user request”, the determination unit 130 determines L₂ to be the QoS control level to be applied to the communication of the information transmission device 10.

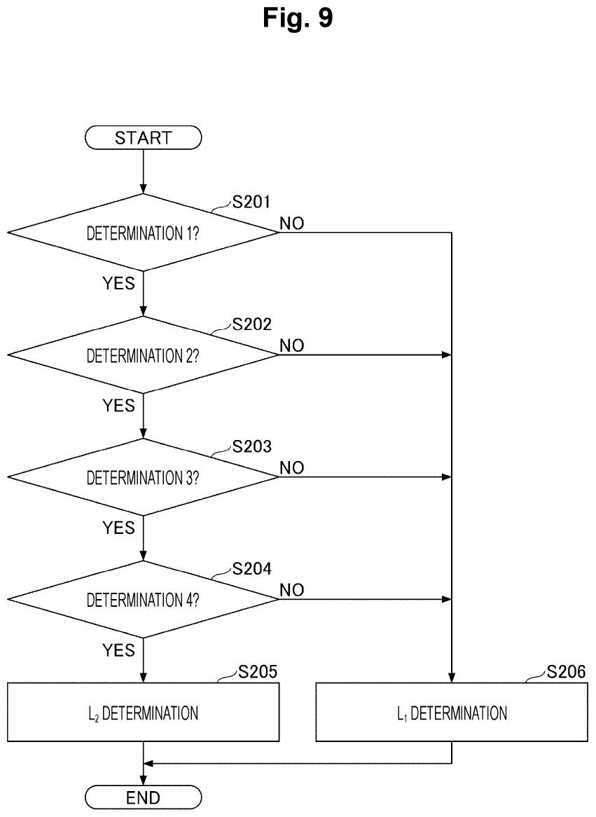

A detailed processing example of Example 1 will be described with reference to a flowchart of FIG. 9.

In S201 (determination 1), the determination unit 130 compares the packet loss rate estimation value R₁ of L₁ with a preset threshold value Rₜₕ₁ (if L₂ is present), and determines whether there is a high possibility that the throughput estimation value of It is smaller than the available band (for example, R₁≤Rₜₕ₁).

For example, in a case where Rₜₕ₁=5, if R₁=0<Rₜₕ₁, then it can be determined that there is a high possibility that the throughput estimation value of L₁ is smaller than the available band. If the determination result of S201 (determination 1) is Yes, the process proceeds to S202. If the determination result is No, the process proceeds to S206.

In S202 (determination 2), the determination unit 130 compares the throughput estimation value T₁ of L₁ with the user request Tᵤ, and determines whether it can be said that T₁ “sufficiently exceeds” Tu (examples: T₁−Tᵤ>Iₜₕ₁, T₁/Tᵤ>Tₜₕ₁, etc.).

For example, in a case where Tₜₕ₁=10, if T₁−Tᵤ=20>Tₜₕ₁, it can be determined that T₁ sufficiently exceeds If the determination result of S202 (determination 2) is Yes, the process proceeds to S203. If the determination result is No, the process proceeds to S206.

In S203 (determination 3), the determination unit 130 compares the packet loss rate estimation value R₂ of L₂ with a preset threshold value Rₜₕ₂, and determines whether there is a high possibility that the throughput estimation value T₂ of L₂ is smaller than the available band (for example, R₂<Rₜₕ₂).

For example, in a case where Rₜₕ₂=1, if R₂=0<Rₜₕ₂, then it can be determined that there is a high possibility that the throughput estimation value of L is smaller than the available band. If the determination result of S203 (determination 3) is Yes, the process proceeds to S204. If the determination result is No, the process proceeds to S206.

In S204 (determination 4), the determination unit 130 compares the throughput estimation value T₂ of L₂ with the user request Tᵤ, and determines whether or not it can be said that T₂ “is close to/has room to exceed” In (examples: Tᵤ−T₂≤Tₜₕ₂, T₂/Tᵤ>Tₜₕ₂, etc.) .

For example, in a case where Tₜₕ₂=5, if Tᵤ−T₂=1<Tₜₕ₂, it can be determined that T₂ “is close to/has room to exceed” Tᵤ. If the determination result of S204 (determination 4) is Yes, the process proceeds to S205. If the determination result is No, the process proceeds to S206. Here, for example, in a case where Tₜₕ₂=5, if Tᵤ−T₂=10>Tₜₕ₂, it is determined that T₂ “is not close to/has no room to exceed” Tᵤ, and the determination result is No.

In S205, the determination unit 130 determines that the user request can also be met by L₂, and determines L₂ to be the QoS control level to be applied to the communication of the information transmission device 10.

In S206, the determination unit 130 determines In to be the QoS control level to be applied to the communication of the information transmission device 10.

### Example 2

In Example 2, the determination unit 130 determines the QoS control level to be applied to the communication of the information transmission device 10 on the basis of the packet loss rate estimation value and the throughput estimation value for L₂.

Specifically, when determining that “there is a high possibility that the throughput estimation value of L₂ is smaller than the available band” and that “L₂ is close to the user request”, the determination unit 130 determines L₂ to be the QoS control level to be applied to communication of the information transmission device 10.

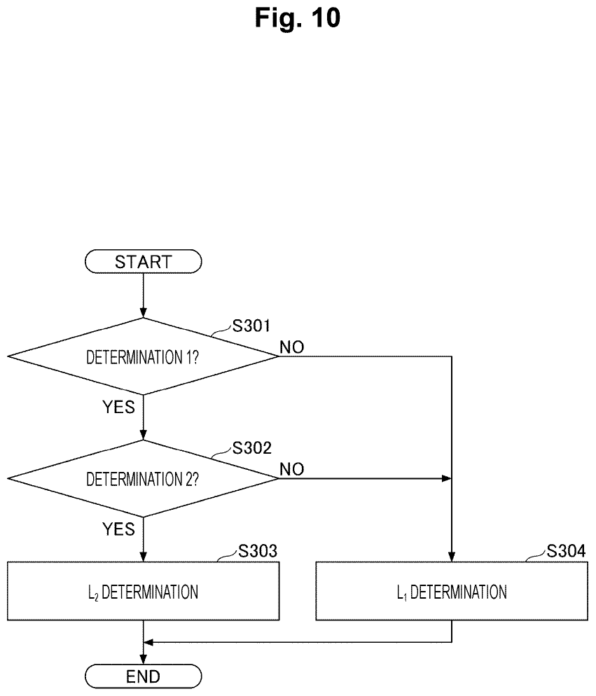

A detailed processing example of Example 2 will be described with reference to a flowchart of FIG. 10.

In S301 (determination 1), the determination unit 130 compares the packet loss rate estimation value R₂ of L₂ with a preset threshold value Rₜₕ₂, and determines whether there is a high possibility that the throughput estimation value T₂ of L₂ is smaller than the available band (for example, R₂<Rₜₕ₂).

For example, in a case where Rₜₕ₂=1, if R₂=0<Rₜₕ₂, then it can be determined that there is a high possibility that the throughput estimation value of L₂ is smaller than the available band. If the determination result of S301 (determination 1) is Yes, the process proceeds to S302. If the determination result is No, the process proceeds to S304.

In S302 (determination 2), the determination unit 130 compares the throughput estimation value T₂ of L₂ with the user request Tu, and determines whether or not it can be said that T₂ “is close to/has room to exceed” Tᵤ (examples: Tᵤ−T₂<Tₜₕ₂, T₂/Tᵤ>Tₜₕ₂, etc.) .

For example, in a case where T_{th2′}=0.8, if T₂/Tᵤ=0.875>Tₜₕ₂, then it can be determined that T₂ “is close to/has room to exceed” In. If the determination result of S302 (determination 2) is Yes, the process proceeds to S303. If the determination result is No, the process proceeds to S304. Here, for example, in a case where Tₜₕ₂′=0.8, if T₂/Tᵤ=0.7<T_{th2′}, it is determined that T₂ “is not close to/has no room to exceed” Tᵤ, and the determination result is No.

In S303, the determination unit 130 determines that the user request can also be met by L₂, and determines L₂ to be the QoS control level to be applied to the communication of the information transmission device 10.

In S304, the determination unit 130 determines L₁ to be the QoS control level to be applied to the communication of the information transmission device 10.

### Example 3

It is assumed that L₂ is applied as the QoS control level according to the determination result of Example 1 or 2 with respect to the communication of the information transmission device 10 at a certain position A (for example, a position close to a wireless base station).

Thereafter, the information transmission device 10 moves and is located in a peripheral portion of the coverage (assumed to be position B).

It is assumed that the control apparatus 100 obtains an estimation value lower than the throughput estimation value at the position A and obtains an estimation value higher than the packet loss rate estimation value at the position A, as the quality estimation result of each QoS control level at the position B. At this time, the control apparatus 100 determines to apply L₁ as the QoS control level by the determination logic of Example 1 or 2, and instructs the NW 200 to apply L₁.

Another example will be described. It is assumed that L₂ is applied as the QoS control level according to the determination result of Example 1 or 2 with respect to the communication of the information transmission device 10 at a certain time A (for example, a time when traffic is not congested). Thereafter, time passes and time B (time when traffic is congested) is reached.

It is assumed that the control apparatus 100 obtains an estimation value lower than the throughput estimation value at the time A and obtains an estimation value higher than the packet loss rate estimation value at the time A, as the quality estimation result of each QoS control level at the time B. At this time, the control apparatus 100 determines to apply L₁ as the QoS control level by the determination logic of Example 1 or 2, and instructs the NW 200 to apply L₁.

### Hardware Configuration Example

The control apparatus 100 described in the present embodiment can be implemented, for example, by causing a computer to execute a program. This computer may be a physical computer or may be a virtual machine on a cloud.

That is, the device can be implemented by executing a program corresponding to processing carried out by the device, using hardware resources built in the computer, such as a central processing unit (CPU) and a memory. The above program can be stored and distributed by being recorded in a computer-readable recording medium (a portable memory or the like). Furthermore, the above program can also be provided through a network such as the Internet or an email.

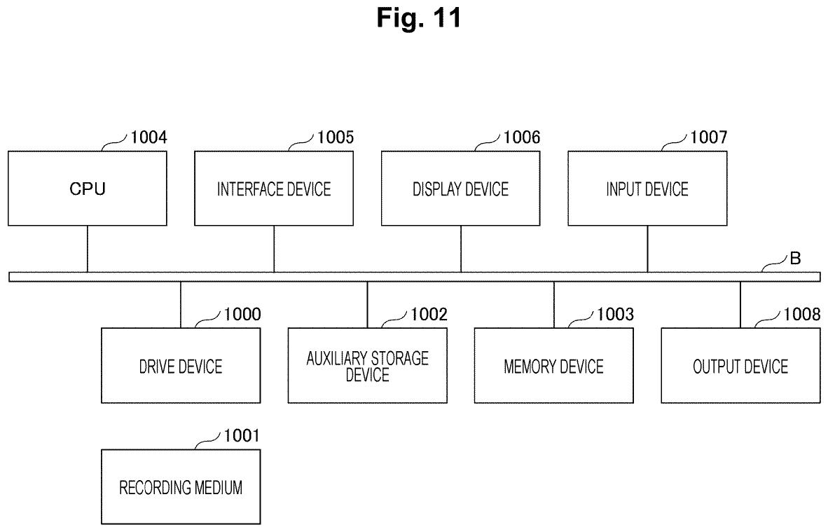

FIG. 11 is a diagram illustrating a hardware configuration example of the computer. The computer in FIG. 11 includes a drive device 1000, an auxiliary storage device 1002, a memory device 1003, a CPU 1004, an interface device 1005, a display device 1006, an input device 1007, an output device 1008, and the like, which are connected to each other by a bus B. Note that the computer may further include a GPU.

A program for implementing processing in the computer is provided by a recording medium 1001 such as a compact disc read-only memory (CD-ROM) or a memory card, for example. When the recording medium 1001 storing the program is set in the drive device 1000, the program is installed from the recording medium 1001 to the auxiliary storage device 1002 via the drive device 1000. However, the program is not necessarily installed from the recording medium 1001 and may be downloaded from another computer via a network. The auxiliary storage device 1002 stores the installed program and also stores necessary files, data, and the like.

When an instruction to start the program is given, the memory device 1003 reads the program from the auxiliary storage device 1002 and stores the program. The CPU 1004 implements a function related to the control apparatus 100 in accordance with the program stored in the memory device 1003. The interface device 1005 is used as an interface for connection to a network or the like. The display device 1006 displays a graphical user interface (GUI) or the like according to the program. The input device 1007 includes a keyboard and a mouse, a button, a touchscreen, and the like and is used to input various operation instructions. The output device 1008 outputs a computation result.

### Summary of Embodiment, Effects, and Like

As described above, according to the technique described in the present embodiment, it is possible to implement control to increase QoS control level only in a case where the QoS control level (communication priority) has to be increased. That is, it is possible to realize control to apply a low QoS control level such as best effort communication as much as possible. As a result, the following effects can be obtained.
Excessive securing of limited wireless NW resources can be avoided (the wireless NW resources can be efficiently utilized).
Estimation of NW/application quality that can be achieved at low QoS control levels, such as best effort communication, can continue. That is, convergence to high QoS control level application due to estimation impossibility can be avoided.

Regarding the above-described embodiments, the following supplementary notes are further disclosed.

### Supplementary Notes

### (Supplementary Note 1)

A control apparatus configured for determining a communication priority for communication of a device, the control apparatus including:
an estimation unit configured to estimate quality related to the communication for each communication priority; and
a determination unit configured to determine the communication priority for the communication of the device based on the quality for the each communication priority estimated by the estimation unit and a requirement condition of the communication.

### (Supplementary Note 2)

The control apparatus according to supplementary note 1, in which the determination unit is configured to determine a communication priority at which the quality estimated by the estimation unit is quality that meets the requirement condition of the communication to be the communication priority for the communication of the device.

### (Supplementary Note 3)

The control apparatus according to supplementary note 1, in which in a case where the determination unit determines that a specific condition is met, the determination unit is configured to determine a communication priority lower than a communication priority at which the quality estimated by the estimation unit is quality that meets the requirement condition of the communication to be the communication priority for the communication of the device.

### (Supplementary Note 4)

The control apparatus according to supplementary note 3, in which the determination unit is configured to determine whether or not the specific condition is met based on a packet loss rate estimated by the estimation unit.

### (Supplementary Note 5)

The control apparatus according to any one of supplementary notes 1 to 4, in which the device is a mobile device, and the estimation unit is configured to estimate the quality based on a past record.

### (Supplementary Note 6)

A communication system including: the device; and the control apparatus of any one of supplementary notes 1 to 5.

### (Supplementary Note 7)

A determination method executed by a control apparatus that determines a communication priority for communication of a device, the determination method including:
an estimation step of estimating quality related to the communication for each communication priority; and
a determination step of determining the communication priority for the communication of the device based on the quality for the each communication priority estimated by the estimation step and a requirement condition of the communication.

### (Supplementary Note 8)

A non-transitory storage medium storing a program for causing a computer to function as each unit in the control apparatus of any one of supplementary notes 1 to 5.

Although the present embodiments have been described above, the present invention is not limited to such a specific embodiment, and various modifications and changes can be made within the scope of the present invention described in the claims.

### REFERENCE SIGNS LIST

10 Information transmission device
20 Information reception device
100 Control apparatus
110 Information acquisition unit
120 Estimation unit
130 Determination unit
140 Instruction unit
150 Storage unit
200 Network
1000 Drive device
1001 Recording medium
1002 Auxiliary storage device
1003 Memory device
1004 CPU
1005 Interface device
1006 Display device
1007 Input device
1008 Output device

1. A control apparatus configured for determining a communication priority for communication of a device, the control apparatus comprising:
an estimation circuit configured to estimate quality related to the communication for each communication priority; and
a determination circuit configured to determine the communication priority for the communication of the device based on the quality for the each communication priority estimated by the estimation circuit and a requirement condition of the communication.

2. The control apparatus according to claim 1, wherein the determination circuit is configured to determine a communication priority at which the quality estimated by the estimation circuit is quality that meets the requirement condition of the communication to be the communication priority for the communication of the device.

3. The control apparatus according to claim 1, wherein in a case where the determination circuit determines that a specific condition is met, the determination circuit is configured to determine a communication priority lower than a communication priority at which the quality estimated by the estimation circuit is quality that meets the requirement condition of the communication to be the communication priority for the communication of the device.

4. The control apparatus according to claim 3, wherein the determination circuit is configured to determine whether or not the specific condition is met based on a packet loss rate estimated by the estimation circuit.

5. The control apparatus according to claim 1, wherein the device is a mobile device, and the estimation circuit is configured to estimate the quality based on a past record.

6. A communication system comprising: the device; and the control apparatus of claim 1.

7. A determination method executed by a control apparatus that determines a communication priority for communication of a device, the determination method comprising:
estimating quality related to the communication for each communication priority; and
determining the communication priority for the communication of the device based on the quality for the each communication priority and a requirement condition of the communication.

8. A non-transitory computer-readable recording medium storing a program for causing a computer to perform the method of claim 7.
